(19) United States
(12) Patent Application Publication
(10) Pub. No.: US 2026/0015160 A1
(43) Pub. Date: Jan. 15, 2026

(54) BLADDER DEPLETION DEVICE

(71) Applicant: Safe Marine Transfer, LLC, Houston, TX (US)

(72) Inventors: James E. Chitwood, Spring, TX (US); Art J. Schroeder, JR., Houston, TX (US)

(73) Assignee: Safe Marine Transfer, LLC, Houston, TX (US)

(21) Appl. No.: 19/336,232

(22) Filed: Sep. 22, 2025

Related U.S. Application Data
(62) Division of application No. 17/755,706, filed on May 5, 2022.

(51) Int. Cl. B65D 88/78; B63B 35/28; B63G 8/42; B65D 88/54

(52) U.S. Cl. CPC B65D 88/78; B63B 35/285; B65D 88/54; B63G 2008/425

(57) ABSTRACT

A subsea material delivery structure, including at least one material storage tank, wherein the material storage tank includes a rigid outer container, at least one pressure balanced inner flexible container. A pinch prevention device may be disposed within the at least one inner flexible container to prevent premature closing of a fluid egress pathway.

### BACKGROUND

Many subsea petroleum production activities require the use of chemicals, mud, or slurries to be added to the active operation to properly operate. Historically, these chemical provisions have been provided through hoses, tubes or pipes bundled into “umbilicals” to supply the chemicals from nearby surface facilities to the respective points of injection. Longer offsets, remote locations and deeper water depths contribute to making umbilical solutions technically challenging and expensive.

In some instances, as an alternative to an umbilical to deliver chemicals or mud, or other material to a subsea location, subsea chemical storage tanks may be used for short-term single purpose use and have relatively small volumes. For example, a number of bladder style chemical storage tanks have been developed for this purpose. Existing subsea chemical storage assemblies may include single wall flexible tanks or bladders that are exposed directly to seawater, which may be contained within a cage or frame device for protection and transportation. However, the sizes of these storage tanks are relatively small (hundreds of gallons) and have relatively low or no reuse ability. Additionally, the application use subsea is typically short term (days). Further, the manner of collapse of the non-rigid tank during depletion may be in a random, chaotic, or non-uniform manner, causing some of the stored chemical or material to be trapped, or pinched off, by the flexible container material and resulting in an inefficient delivery of the stored material.

### SUMMARY OF THE CLAIMED EMBODIMENTS

In one aspect, embodiments of the present disclosure relate to a subsea material delivery structure including at least one material storage tank, wherein the material storage tank includes an outer container, wherein the outer container is rigid; at least one inner flexible container, wherein the at least one inner flexible container is pressure balanced; and a flexible container pinch prevention device disposed within the at least one inner flexible container.

In another aspect, embodiments of the present disclosure relate to a subsea material delivery structure, including at least one material storage tank, wherein the material storage tank includes an outer container, wherein the outer container is rigid; at least one inner flexible container, wherein the at least one inner flexible container is pressure balanced; and a pinch prevention device disposed in, and secured to a top of, the at least one inner flexible container.

In another aspect, according to embodiments disclosed herein is a subsea material delivery structure, including at least one material storage tank, wherein the material storage tank includes an outer container, wherein the outer container is rigid; at least one inner flexible container, wherein the at least one inner flexible container is pressure balanced; a helically wound wire structure disposed within the at least one inner flexible container.

In another aspect, according to embodiments disclosed herein is a subsea material delivery structure, including at least one flexible container; and a helically wound wire structure disposed within the at least one flexible container; wherein the helically wound wire structure is secured within the at least one flexible container by one or more of hangers or one or more loops, and wherein the helically wound wire structure is fixed to at least one outflow valve disposed in the at least one flexible container.

In other aspect, according to embodiments disclosed herein is a material delivery structure, including at least one flexible container, and a helically wound wire structure disposed within the at least one flexible container, the helically wound wire structure being from 0.125 inch to 3 inches in diameter, 1 foot to 10 feet in length, having a wire diameter from 1/32 inch to ½ inch, and a pitch of 1/32 inch to 1 inch and made of one or more of a metal, a composite, and a semi-rigid material, wherein the helically wound wire structure is fixed to at least one inflow/outflow valve disposed in the at least one flexible container

Other aspects and advantages will be apparent from the following description and the appended claims.

### BRIEF DESCRIPTION OF DRAWINGS

FIG. 1 shows a diagram of a storage tank according to embodiments of the present disclosure.

FIG. 2 shows a diagram of a storage tank according to embodiments of the present disclosure.

FIG. 3 shows a diagram of a storage tank according to embodiments of the present disclosure.

FIG. 4 shows a diagram of a storage tank according to embodiments of the present disclosure.

FIG. 5 shows a diagram of a storage tank according to embodiments of the present disclosure.

FIG. 6 shows a diagram of a storage tank according to embodiments of the present disclosure.

FIG. 7 shows a diagram of a storage tank according to embodiments of the present disclosure.

FIG. 8 shows a diagram of a storage tank according to embodiments of the present disclosure.

### DETAILED DESCRIPTION

Disclosed herein are chemical delivery systems including a flexible storage bladder and a bladder depletion device. In some embodiments, the chemical delivery system may be associated with a rigid subsea storage tank. Such chemical delivery systems may be capable of storing different materials, such as fluids, liquids, mixtures, slurries, etc. The material is stored in a bladder, or multiple bladders, and in some embodiments may be located within a subsea storage tank, and a pump or hydrostatic pressure differential withdraws this fluid through an outlet valve or opening penetrating the storage tank and connected to the bladder or bladders. Periodically, the bladders may be replenished or filled with fluid to continue the system's function.

As used herein, the terms “bladder” and “flexible container” may be used interchangeably.

Depending upon bladder construction, ports, outlets, etc. and other factors like differential pressures, the bladder may collapse during fluid withdrawal in ways that pinch-off or trap large percentages of the contained fluids within the bladder. In subsea environments, large differential pressures combined with the removal or depletion of materials may also result in a momentary vacuum (a pressure within the bladder that is below hydrostatic pressure) being formed near the outlet port or outflow valve of the bladder, causing the bladder to pinch near the outlet, cutting off the flow of material through the outlet port or valve.

Additionally, different materials may be stored in the bladder. These materials may have densities less than or greater than the surrounding environment, such as seawater. If the material is less dense than seawater, the bladder may float within the subsea storage tank, collapsing upward. If the material is of a higher density than seawater, the bladder may sink within the subsea storage tank, collapsing downward. In both situations, the pressure of the seawater on the bladder may alter the topography of the bladder, creating areas where the boundaries, top, bottom, sides of the bladder may come near to and/or in contact with each other. When this occurs, and material is being removed from the bladder, the bladder may pinch, trapping material within the bladder, and preventing egress of the material to the outlet port.

The devices described herein may create, and hold open, material flow passages within the bladder which may enable maximum stored material removal.

A known solution is to create a fluid path within the collapsed bladder so trapped fluids can flow to the exit port. Such solutions may include a perforated hose contained within the bladder to form this fluid flow path drain. Another alternative is embossing small grooves in the inner walls of the bladder. These grooves form a trapped fluid drain alternative. A third alternative is a net structure within the bladder that physically separates the two walls of the collapsing bladder creating a fluid flow path. Alternatives such as these above all use materials of construction which may be incompatible with chemicals used in subsea operations. For example, U.S. Pat. No. 8,220,749 discloses a perforated tube made of plastic or Teflon. Such a material has a lack of compatibility with subsea drilling chemicals, such as xylenes. The plastic hose material can be made resistive, but needs a film applied. If the film were to be applied to the inside of the tubing, then when the tube is perforated to allow passage of chemicals, the film would be cut, exposing the substrate hose material to the corrosive chemicals.

In other embodiments, the material stored within the bladder may include slurries which may take many forms, such as drilling fluids, drag reducing agents (DRA), and slurries of materials with small spheres which may provide buoyancy. Such materials may plug the perforations of prior proposed solutions, shutting off the intended flow. Similar “filtering” and plugging could likewise occur with netting or grooves.

Further, the solutions described above are generally in use in aviation. These solutions may be incompatible in subsea environments due to the high differential pressures and varying topographies of the bladder in these environments.

Bladder collapse-prevention devices disclosed herein may include a helically wound wire structure or coil, such as a long compression spring, which may be placed within a bladder of a subsea chemical delivery system. The coil may inherently be flexible and embodied with sufficient radial structural strength to hold a flow path open within a collapsing bladder, even at high subsea pressures that may be encountered. With proper material selection, this helical coil may be compatible with the most aggressive chemicals that may be stored in the bladder. The construction of the coil may be smooth and may not include sharp edges or ends that may harm the bladder, such as by puncture, tearing, or scratching. The coil may be constructed of metal, composite, or other rigid or semi-rigid material.

The helically wound wire structure may be in many forms and have many various dimensions, where such dimensions may depend upon the size of the tank or bladder being used. For example, the helically wound wire structure may be from 0.125 inches to 6 inches in diameter, such as from 1 inches to 3 inches in diameter.

Further, the helically wound wire structure may be of sufficient length to prevent the bladder from collapsing closed along the x-, y-, and/or z-axes. Such a length may be from 1 foot to 400 feet in length. In one or more embodiments, such helically wound wire structure may be from 20 feet to 120 feet in length.

Additionally, the helically wound wire structure may have a wire diameter sufficient to prevent the helically wound wire structure from collapsing under the weight of the bladder and subsea pressure. The wire diameter may be from 1/32 inch to 1 inch in diameter, such as from 1/16 inch to 5/16 inch in diameter, or such as ¼ inch to 1 inch.

Additionally, the parameters and materials of construction may be selected such that the helically wound wire structure may be of sufficient flexibility to allow for ease of insertion into the bladder and to allow the bladder to be carefully folded for shipment.

Further, the pitch of the helically wound wire may be from 1/32 inch to 3 inches in length, such as from ¼ inch to 3 inch in length. Accordingly, the helically wound wire may be shaped to prevent collapse along the wire diameter while allowing passage of materials through the helically wound wire structure and to exit through a valve, or otherwise penetrate out of the bladder. Additionally, the helically wound wire structure may be rigid enough to resist compression and expansion. Alternatively, the helically wound wire structure may allow for compression or expansion. Such compression or expansion may be in an amount of from 1% of the original length to 50% of the original length, such as from 10% to 20%. In any event, the compression or expansion may be specifically designed to not compromise the integrity of the bladder.

Further, various sized bladders may be used which may necessitate the use of a different sized helically wound wire structure. For example, a 200 bbl bladder may be used. In such a bladder, the helically wound wire structure may be from 0.125 inch to 3 inch in diameter, 1 foot to 40 feet in length, have a wire diameter from 1/32 inch to ½ inch, and a pitch of 1/32 inch to 1 inch. In another embodiment, a 3000 bbl bladder may be used. In such a bladder the helically wound wire structure may be from 2 inch to 6 inch in diameter, 40 foot to 120 foot in length, have a wire diameter from ¼ inch to 1 inch, and a pitch of 1 inch to 3 inch. Bladder sizes from a few barrels to 10,000 barrels or more are contemplated herein. The helically wound wire structure may be sized appropriately for the bladder volume and dimensions, including the dimensions of the inlets and outlets.

In some embodiments, the pitch of the coil structure may vary along a length of the coil, decreasing from a bladder outlet end to a most distant end from the bladder outlet. In this manner, the bladder may selectively collapse as the liquid or slurry contained within the bladder is depleted, allowing, for example, a nearly full collapse at the distal end as the internal liquid or slurry volume diminishes and is pushed toward the bladder outlet. Collapsibility and efficient drainage of the bladder may be influenced, for example, based on the structure of the coil, including outside diameter of the coil, thickness of the coil wire as well as pitch between coils, among other factors. In other embodiments, the diameter of the coil may vary along its length, greatest proximate the bladder outlet, least most distal from the bladder outlet, enabling use of a greater volume than would be permitted by a coil of consistent diameter. In yet other embodiments, diameter may vary along a length of a coil.

In one or more embodiments disclosed herein is a method of installation of the helically wound wire structure in a bladder to be disposed subsea. The helically wound wire structure may be solidly connected, such as to an outflow port, valve or an opening which forms part of the bladder, to allow inflow or outflow of material. In some embodiments, the material being stored in the bladder may be of greater density than the surrounding environment, such as seawater. Accordingly, the outflow valve may be disposed near the bottom of the bladder within which the helically wound wire structure may be disposed. The helically wound wire structure, connected to the outflow valve near the bottom of the bladder, and if of a higher density than the material being stored, may then be drawn down through its own weight and lie on the bottom of the bladder. The helically wound wire structure placed on the bottom of the bladder may form an approximately straight line, or the helically wound wire structure may curve back and forth, increasing the contact area of the helically wound wire structure and bladder. In some embodiments, the coil may be secured to the bladder internal walls at intervals in order to be retained in a desired location. For convenience of construction and for material compatibility, the coil may be secured with loops of bladder material, similar to belt loops on a pair of pants, for example. Additionally, in one or more embodiments where the coil is connected at one end, the terminal end of the coil may be terminated in such a way as to prevent sharp edges which may pierce the bladder. Such a terminated end may also be secured to the bladder.

In other embodiments, the liquid being stored in the bladder may have a density less than the surrounding environment, such as seawater. Accordingly, the outflow valve or opening may be disposed near the top of the bladder. Using a similar connection method, the helically wound wire structure may be connected to the outflow port and will be positioned at the top of the bladder to efficiently drain the bladder.

In other embodiments, different liquids may be stored in the bladder on a rolling basis. For example, a low density material may be stored in the bladder initially. Upon depletion of the low density material, the bladder may be filled with a high density material. It is also contemplated that that high density material may be loaded first, and the low density second. Further, other alternatives are also contemplated. Accordingly, the outflow valve or port may be disposed near the center of the bladder. This may allow for the outflow to avoid becoming blocked in embodiments where the bladder floats or where the bladder sinks. Alternatively, auxiliary equipment may be positioned on the sides of the structure, such that the overall structure may be “flipped” or manipulated to allow for use of a material of higher or lower density.

In other embodiments, the helically wound wire structure may be fixed in a certain position based on the density of the stored material, or the difference in density between the stored material and the ambient environment. For example, in one or more embodiments where a stored material has a greater density than the ambient environment, the helically wound wire structure may be fixed to the bottom of the bladder.

The solid connection mechanism may be such that the helically wound wire structure is connected to a bushing, a flange, an elbow, a tee, or similar device depending upon the function design of the port and the helically wound wire structure's attachment. The bushing may be threaded into the outflow valve, opening, or port. This installation method may occur during the production of the bladder, and thus the coil may already be present when the bladder is initially filled. In such an embodiment, the bushing may form a fluid passage from the interior of the bladder, through the outflow valve, and into a piping or header assembly for injection.

In other embodiments, the helically wound wire structure may be installed in the bladder, after bladder fabrication, by feeding the wire structure through the outflow valve or port or opening from the outside of the bladder. In such an embodiment, the helically wound wire structure may include a spring clip, flange, or other such connection device for connecting the helically wound wire structure to the outflow valve, port, or opening, thereby securing one end while the loose end is disposed within the bladder. During installation, after bladder fabrication, the helically wound wire structure may be installed using a pull cord attached to a pull head of the structure. In such a fashion, the helically wound wire structure may be wrapped in a plastic sleeve, or other type sleeve, and may be pulled into the bladder and through the interior hangers, or loops. The plastic sleeve may serve to prevent the structure from getting caught on the hangers or loops. Once the structure is installed, the plastic sleeve may then be disconnected from the pull head and removed through the port or opening that the structure was just pulled through or a second port deposed on the same bladder.

In other embodiments, the helically wound wire structure may form a toroidal shape within the bladder, where both terminal ends are connected to the outflow valve by one or more of the above identified methods. This arrangement may provide for greater coverage within the bladder for preventing pinching or collapse.

In yet other embodiments, the bladder may be equipped with separate inflow and outflow valves or ports. Any of the above installation methods may work in these types of bladders. Further, the helically wound wire structure may be connected at one end to the inflow valve or port, and connected at the other end to the outflow valve or port. The positioning of the helically wound wire structure within the bladder may be accomplished during production of the bladder via bushings, holding clips, hoops, belts, flanges, etc., or may be done after the bladder is made by feeding one end of the wire structure through either the inflow or outflow valve, and connecting this end to the opposite valve prior to connect the wire structure to valve through which it was threaded.

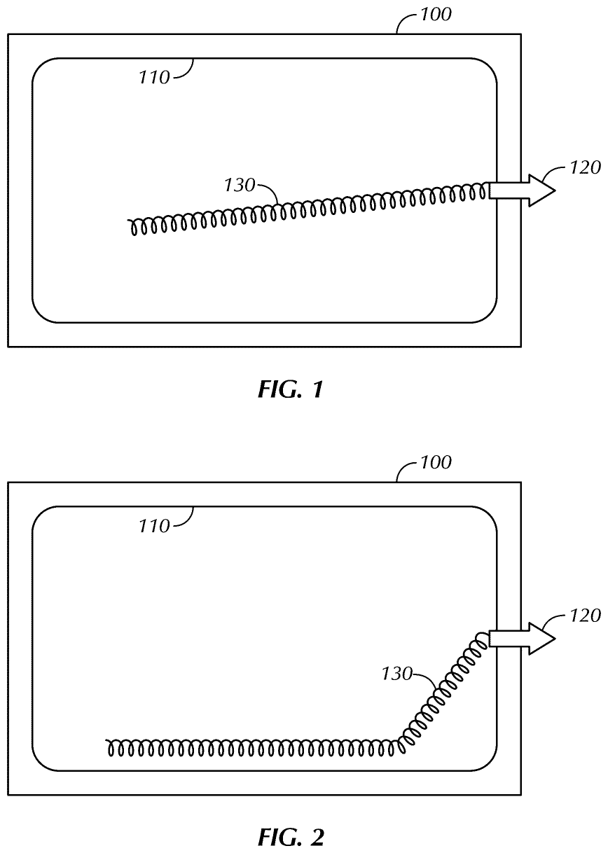

FIG. 1 illustrates a top view of a rigid tank 100 containing a bladder 110 having disposed therein a helically wound wire structure 130, according to one or more embodiments discloses herein, where the wire structure 130 is connected to the outflow valve 120 and the other end is loose. In this view, the helically wound wire structure 130 is generally shown in the interior of the bladder 110. The helically wound wire structure 130 may be connected to the bottom of the bladder 110, the top of the bladder 110, connected on both ends (i.e., on the outflow valve 120 and the opposite wall of the bladder 110), or in any other configuration, as necessary.

FIG. 2 illustrates a similar embodiment, but from a side view. In FIG. 2 the helically wound wire structure 130 is illustrated as connected to the outflow valve 120 and the other end of the helically wound wire structure 130 is resting on the bottom of the bladder 110, such as where the helically wound wire structure 130 is made of a material having a greater density than the material stored within the bladder 110.

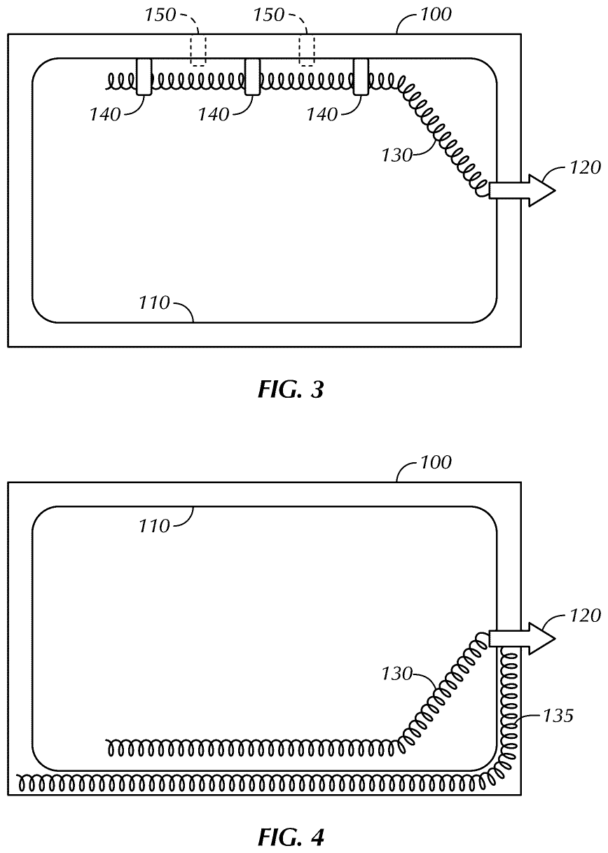

Alternatively, or additionally, as illustrated in FIG. 4, a separate helically wound wire structure 135 may be disposed in the space between the at least one flexible bladder 110 and the rigid tank 100. The length of helically wound wire structure 135 may be connected to the tank on one end of the helically wound wire structure, or may be connected at both ends. Further, both ends of the helically wound wire structure may be connected to the same point of the rigid structure 110 forming a loop. Such a connection point may also be an inflow/outflow valve 120 or port which may allow seawater to inflow or outflow of the rigid structure, providing pressure balance on the at least one flexible bladder 110. The length of helically wound wire structure 135 disposed between the rigid tank 100 and the bladder 110 may prevent, or limit, the tendency for the at least one flexible bladder 110 to seal off one side of the rigid structure 100, prevent fluid contact of the seawater with the seawater inflow/outflow valve or port. In such a fashion, the length of helically wound wire structure 135 may be disposed around the top or bottom of the rigid structure 100, and may form a continuous coil loop.

In one or more embodiments, a material with a density less than seawater is stored in the bladder 110, but material compatibility and/or structural needs of the helically wound wire structure 130 may require the helically wound wire structure 130 to be made of a material of greater density than the material being stored. Instead of having the helically wound wire structure 130 resting on the bottom of the bladder 110, the coil may be secured to the top of the bladder, such as illustrated in FIG. 3. The helically wound wire structure 130 may be secured by one or more clips, rings, ties, fixed loops, or belt loops 140. Further, the bladder 110 may also be secured to the top of the rigid container by one or more clips, rings, ties, fixed loops, or belt loops 150. During depletion of the material stored within the bladder, the lower portion of the bladder 110 may rise toward to the top where the helically wound wire structure 130 is secured. In such a fashion, the helically wound wire structure 130 may be secured such that damage to the bladder is minimized or negated. Likewise, helically wound wire structure 130 design may result in the helically wound wire structure 130 being less dense than the material being stored, and where the material is of greater density than the surrounding environment, a helically wound wire structure 130 may be secured to the bottom of the bladder 110 in a similar fashion.

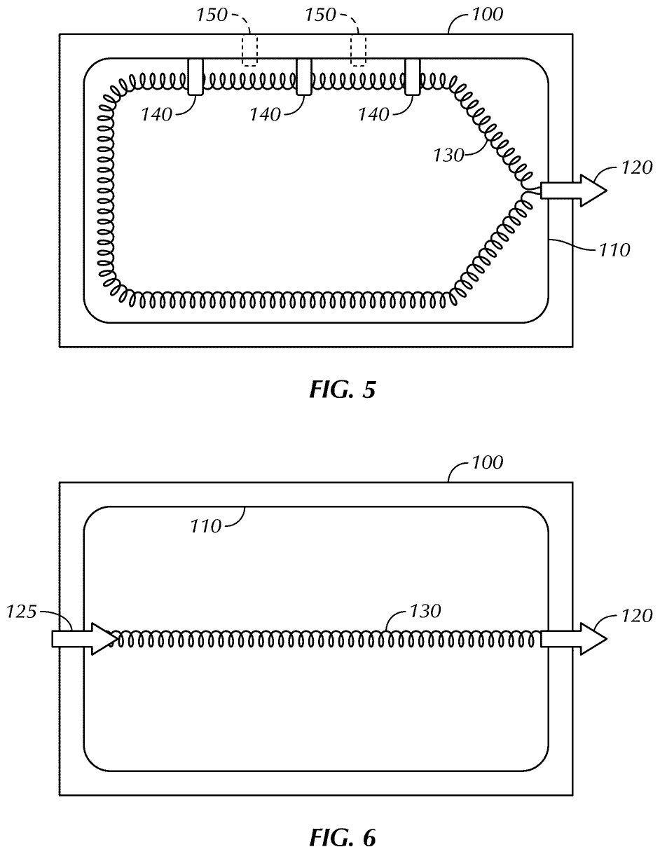

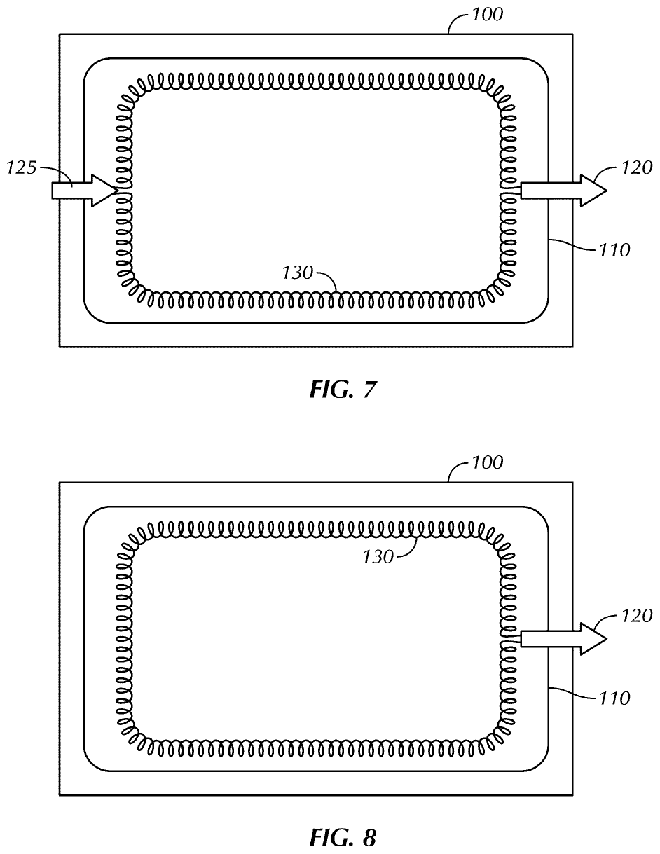

Further, in one or more embodiments, as illustrated in FIG. 5, the helically wound wire structure 130 may form a continuous loop inside the bladder 110. As illustrated, the loop of helically wound wire structure 130 is secured to the top of the top of bladder 140 and may rest along the bottom of the bladder 110. As illustrated in FIG. 6, the helically wound wire structure 130 may be connected on one side to outflow valve or port 120, and on the other end by inflow valve or port 125. In this configuration, the helically wound wire structure 130 may be partially pulled taught such that it is suspended off the bottom of the bladder 110, or it may rest on the bottom of bladder, may be secured to the top of the bladder, or may form a continuous loop between the inflow and outflow valves or ports (such as illustrated in FIG. 7).

Additionally, FIG. 8 is a top view of the rigid structure 100. In one or more embodiments, the helically wound wire structure 130 may rest along the bottom of bladder 110, and form a continuous loop connected to outflow valve 120 at both ends.

A subsea storage tank having a bladder equipped with such a helically wound wire structure may be used in a number of subsea applications. For example, the subsea storage tank may have a rigid outer container and at least one or more flexible inner containers, each with the above described helically wound wire structure. The inner containers may be, for example, bladders made of a flexible, durable material suitable for storing liquids in a subsea environment, such as polyvinyl chloride (“PVC”) coated fabrics, ethylene vinyl acetate (“EVA”) coated fabrics, nitrile coated fabrics, or other polymer composites, which are also compatible with the materials to be contained without degrading. The inner containers may contain seawater and at least one stored material. The inner containers are pressure balanced such that as the stored material is added or removed from the second inner container, a corresponding volume of seawater may outflow or inflow from the first inner container.

As described herein, the helically wound wire structure may be connected to the appropriate inflow or outflow valve. However, in some embodiments, it would be appreciated that the inflow or outflow valve is connected to a corresponding inflow or outflow port. The helically wound wire structure may then be connected to the inflow and/or outflow port, as described above.

During the addition and removal of seawater and stored materials from the bladder, the helically wound wire structure may prevent the one or more bladders from pinching shut and may allow for the maximum depletion of materials from the bladder.

The inner containers, or bladders, may be equipped with closure valves that close and seal-off when the associated inner container fully depletes, which may protect the integrity of the inner containers by not subjecting the inner containers to potentially large differential pressures.

Further, the volume of the outer container remains fixed, and the volumes of the at least two inner containers are variable. For example, while the stored materials may be added or removed from the second inner container through a controlled opening having the helically wound wire, a corresponding volume of seawater may outflow or inflow from the first inner container through another controlled opening having a helically wound wire structure.

Alternatively, as previously described, seawater may be disposed in the annular space between the rigid container and the one or more inner containers, and may function to pressure balance the one or more inner containers. The seawater may be necessary to prevent large differential pressures from forming and compromising the integrity of the outer container. However, this same seawater may be responsible for the unintended pinching of the inner bladders, which is why the helically wound wire structure may be necessary.

Additionally, the subsea storage tank may be equipped with at least one buoyancy tank. Such a buoyancy tank may allow for the deployment and recovery of the subsea storage tank. In one or more embodiments, the subsea storage tank may be of the type disclosed in U.S. Pat. Nos. 9,156,609 and 9,079,639.

Further, in one or more embodiments disclosed herein, the flexible bladder may be disposed subsea without an outer container. For example, the subsea material delivery structure may include at least one flexible container, and the helically wound wire structure disposed within the at least one flexible container. In such an embodiment, the helically wound wire structure may be secured within the at least one flexible container by one or more of hangers and loop, and may be fixed to at least one outflow valve disposed in the at least one flexible container. Other embodiments such as those described above, but without the outer container, are also contemplated herein.

Further, in one or more embodiments disclosed herein, the flexible bladder may be used on a host ship or facility, on land, or in other non-subsea locations, such as a fuel farm. In such embodiments, the flexible bladder may include a helically wound wire structure disposed within the at least one flexible container. The helically wound wire structure may be from 0.125 inch to 3 inches in diameter, 1 foot to 10 feet in length, have a wire diameter from 1/32 inch to ½ inch, and a pitch of 1/32 inch to 1 inch and made of one or more of a metal, a composite, and a semi-rigid material.

### Examples

Chemical delivery systems were tested to validate and quantify performance and effectiveness of pinch prevention devices according to embodiments disclosed herein. The tests covered a range of bladder sizes from 200 gallons (approximately 4.75 bbl) to 20,000 gallons (approximately 475 bbl) for a variety of fluids and slurries. During these tests, bladder pinch prevention devices according to embodiments disclosed herein enabled depletion of a 20,000 gallon bladder, that was not contained within an outer rigid container, to a volume of less than 20 gallons (less than 0.1 volume percent residual liquid). Testing of a 500 gallon bladder within a rigid outer container yielded a similar 0.1 volume percent residual liquid (approximately 0.5 gallons). Additional testing on bladders between 500 and 20,000 gallons, both in a rigid outer container and without a rigid outer container yielded similar results. Embodiments disclosed herein have thus been proven to effectively prevent pinch of a bladder while allowing depletion of bladder contents to less than 0.5 volume percent residual; less than 0.2 volume percent residual in other embodiments, and less than 0.1 volume percent residual in other embodiments. Additionally, multiple tests have revealed predictable, repeatable results regarding percent depletion across a variety of bladder size, fluid types and device configuration. As used herein, volume percent residual is calculated based on the volume of fluid remaining in a bladder (residual) as compared to the capacity of the bladder (i.e., not calculated based on the volume of fluid initially placed in the bladder during the fill-empty cycle).

Utilization of the device according to one or more embodiments disclosed herein allows for a much wider range of bladder fluid delivery (efficiency), as well as operational flexibility and an element of safety, due to the fact that the fluid depletion levels can be reliably predicted and consistently achieved.

While the disclosure includes a limited number of embodiments, those skilled in the art, having benefit of this disclosure, will appreciate that other embodiments may be devised which do not depart from the scope of the present disclosure. Accordingly, the scope should be limited only by the attached claims.

1. A subsea material delivery structure, comprising:
at least one material storage tank, wherein the material storage tank comprises:
an outer container, wherein the outer container is rigid;
at least one inner flexible container, wherein the at least one inner flexible container is pressure balanced; and
a pinch prevention device disposed within the at least one inner flexible container.

2. The structure of claim 1, wherein the pinch prevention device comprises a helically wound wire structure.

3. The structure of claim 2, the helically wound wire structure being from 0.125 inch to 3 inch in diameter, 1 foot to 10 feet in length, have a wire diameter from 1/32 inch to ½ inch, and a pitch of 1/32 inch to 1 inch.

4. The structure of claim 2, the helically wound wire structure being from 2 inch to 6 inch in diameter, 40 feet to 120 feet in length, have a wire diameter from ¼ inch to 1 inch, and a pitch of 1 inch to 3 inch.

5. The structure of claim 2, wherein the helically wound wire structure being made of one or more of a metal, a composite, and a semi-rigid material, wherein the helically wound wire structure is configured to resist collapsing or folding.

6. The structure of claim 1, further comprising a second pinch prevention device disposed between the outer container and the at least one inner flexible container.

7. The structure of claim 1, wherein the at least one inner flexible container is disposed within the outer container, and wherein one or more of an outflow port, an inflow port, and an outflow/inflow port connects the at least one inner flexible container to the outer container and allows material to travel into and out of the at least one inner flexible container.

8. The structure of claim 7, wherein the pinch prevention device is connected to one or more of the outflow port, the inflow port, and the outflow/inflow port.

9. The structure of claim 8, wherein the one or more of the outflow port, the inflow port, and the outflow/inflow port are located proximate a top of the outer container.

10. The structure of claim 8, wherein the one or more of the outflow port, the inflow port, and the outflow/inflow port are located proximate a bottom of the outer container.

11. The structure of claim 8, wherein the one or more of the outflow port, the inflow port, and the outflow/inflow port are located proximate a center of the outer container.

12. The structure of claim 8, wherein the one or more of the outflow port, the inflow port, and the outflow/inflow port are equipped with a closure valve that shuts and seals off the at least one inner flexible container when the at least one inner flexible container is depleted.

13. A subsea material delivery structure, comprising:
at least one material storage tank, wherein the material storage tank comprises:
an outer container, wherein the outer container is rigid;
at least one inner flexible container, wherein the at least one inner flexible container is pressure balanced; and
a pinch prevention device disposed in, and secured to a top of or a bottom of, the at least one inner flexible container.

14. The structure of claim 13, wherein the pinch prevention device comprises a helically wound wire structure.

15. The structure of claim 13, wherein the helically wound wire structure may be made of one or more of a metal, a composite, and a semi-rigid material, wherein the helically wound wire structure is configured to resist collapsing or folding.

16. The structure of claim 13, wherein the at least one inner flexible container is disposed within the outer container, and wherein one or more of an outflow port, an inflow port, and an outflow/inflow port connects the at least one inner flexible container to the outer container and allows material to travel into and out of the at least one inner flexible container.

17. The structure of claim 16, wherein the pinch prevention device is connected to one or more of the outflow port, the inflow port, and the outflow/inflow port.

18. The structure of claim 17, wherein the one or more of the outflow port, the inflow port, and the outflow/inflow port are located proximate a top of the outer container.

19. The structure of claim 17, wherein the pinch prevention device is secured to a top portion of the at least one inner flexible container.

20. A subsea material delivery structure, comprising:
at least one material storage tank, wherein the material storage tank comprises:
an outer container, wherein the outer container is rigid;
at least one inner flexible container, wherein the at least one inner flexible container is pressure balanced;
a helically wound wire structure disposed within the at least one inner flexible container; and
at least one buoyancy tank.

21. The structure of claim 20, wherein the helically wound wire structure may be from 0.125 inch to 3 inch in diameter, 1 foot to 10 feet in length, have a wire diameter from 1/32 inch to ½ inch, and a pitch of 1/32 inch to 1 inch.

22. The structure of claim 20, wherein the helically wound wire structure may be from 2 inch to 6 inch in diameter, 40 feet to 120 feet in length, have a wire diameter from ¼ inch to 1 inch, and a pitch of 1 inch to 3 inch.

23. The structure of claim 20, wherein the helically wound wire structure may be made of one or more of a metal, a composite, and a semi-rigid material, wherein the helically wound wire structure is configured to resist collapsing or folding.

24. The structure of claim 20, further comprising a second helically wound wire structure disposed between the outer container and the at least one inner flexible container.

25.-40. (canceled)
